(19) United States
(12) Patent Application Publication
(10) Pub. No.: US 2009/0165255 A1
(43) Pub. Date: Jul. 2, 2009

(54) HANDLE ASSEMBLY FOR HARD DISK CASE

(75) Inventors: Te-Sheng LIU, Taichung City (TW); Yu-Chen Chu, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: UNIVERSAL SCIENTIFIC INDUSTRIAL CO., LTD., NAN TOU (TW)

(21) Appl. No.: 12/172,936

(22) Filed: Jul. 14, 2008

(30) Foreign Application Priority Data
Dec. 26, 2007 (TW) 96222189

(51) Int. Cl. G11B 33/00

(52) U.S. Cl. 16/422

(57) ABSTRACT

A handle assembly for use in cooperation with a hard disk case includes a base with a first retaining portion, a handle pivotally connected with the base, a movable member mounted to a connecting end of the handle. The movable member is movable between a first position where a second retaining portion of the movable member is engaged with the first retaining portion of the base such that the handle cannot be pivotable relative to the base, and a second position where the second retaining portion of the movable member is disengaged from the first retaining portion of the base such that the handle can be pivotable relative to the base. An elastic member has two ends respectively connected to the handle and the movable member for providing a rebound force to the movable member.

### BACKGROUND OF THE INVENTION

1. Field of the Invention

The present invention relates generally to a hard disk case, and more specifically to a handle assembly for use in cooperation with a hard disk case.

2. Description of the Related Art

A conventional removable hard disk drive is screwed to a hard disk case that is detachably mounted in a computer case such that the hard disk drive and the hard disk case have to be taken out of the computer case together if the hard disk drive must be removed out of the computer case.

The hard disk case generally includes a case body for installation of the hard disk drive, a base connected to the case body, and a handle pivoted to the base. When wanting to mount the hard disk case in the computer case, a user may force the handle to pivotally move toward the base such that a retaining portion, such as a hook, of the handle and a retaining portion, such as a hook, of the base can be engaged with each other, and at the same time, the hard disk drive inside the hard disk case can be inserted into and electrically connected with a connector of the computer case. On the other hand, when wanting to dismount the hard disk case from the computer case, the user can force the retaining portion of the handle into disengagement from the retaining portion of the base such that the handle can be pivotally moveable and then can be pulled outwardly for taking the hard disk case together with the hard disk drive out of the computer case.

However, because both of the retaining portion of the handle and the retaining portion of the base are made of plastics having a certain flexibility, the engagement and disengagement of the retaining portions of the handle and the base through pressing and pulling the handle will be laborious, causing inconvenience of assembly. Further, if one of the retaining portions of the handle and the base is damaged, the whole handle or base will need to be replaced by a new one, resulting in inconvenience of repair and high maintenance cost.

### SUMMARY OF THE INVENTION

The present invention has been accomplished in view of the above-noted circumstances. It is one objective of the present invention to provide a handle assembly for use in cooperation with a hard disk case, which is convenient in assembly and repair and can lower maintenance cost.

To achieve this objective of the present invention, the handle assembly for use in cooperation with a hard disk case comprises a base, a handle, a movable member, and an elastic member. The base has a first retaining portion. The handle has a pivoting end pivotally connected with the base and a connecting end. The movable member is movably mounted to the connecting end of the handle and movable between a first position where a second retaining portion of the movable member is engaged with the first retaining portion of the base such that the handle cannot be pivotable relative to the base, and a second position where the second retaining portion of the movable member is disengaged from the first retaining portion of the base such that the handle can be pivotable relative to the base. The elastic member has two ends respectively connected to the handle and the movable member for providing a rebound force to the movable member.

Accordingly, the base and the handle can be engaged to or disengaged from each other by means of the reciprocal movement of the movable member. Because of the installation way of the moveable member, the assembly of the handle and the base can be enhanced and convenient. Besides, if the first retaining portion is damaged, the user can individually exchange the movable member for a new one without exchanging the whole handle, thereby lowering the maintenance cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of the handle assembly according to a preferred embodiment of the present invention;

FIG. 2 is an exploded view of the handle assembly according to the preferred embodiment of the present invention;

FIG. 3 is an exploded view of a part of the handle assembly according to the preferred embodiment of the present invention, showing the handle and the movable member;

FIG. 4 is a perspective view of a part of the handle assembly according to the preferred embodiment of the present invention, showing that the handle and the movable member are assembled;

FIG. 5 is a partially cutaway view of the handle assembly according to the preferred embodiment of the present invention, showing the movable member is located at the first position;

FIG. 6 is another partially cutaway view of the handle assembly according to the preferred embodiment of the present invention, showing the movable member is located at the second position;

FIG. 7 is still another partially cutaway view of the handle assembly according to the preferred embodiment of the present invention, showing the second inclined surface of the movable member is moved along the first inclined surface of the base;

FIG. 8 is still another partially cutaway view of the handle assembly according to the preferred embodiment of the present invention, showing the handle is pivoted away from the base, and

FIG. 9 is a perspective view of the handle assembly according to the preferred embodiment of the present invention, showing the handle is pivoted away from the base.

### DETAILED DESCRIPTION OF THE INVENTION

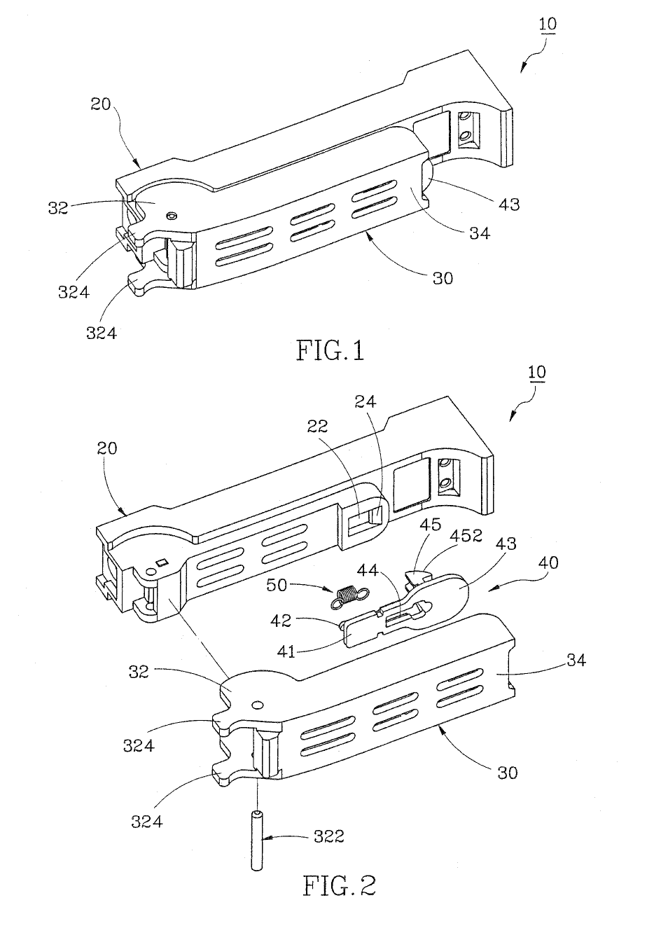

As shown in FIGS. 1 and 2, a handle assembly 10 for use in cooperation with a hard disk case (not shown) in accordance with a preferred embodiment of the present invention comprises a base 20, a handle 30, a movable member 40, and an elastic member 50.

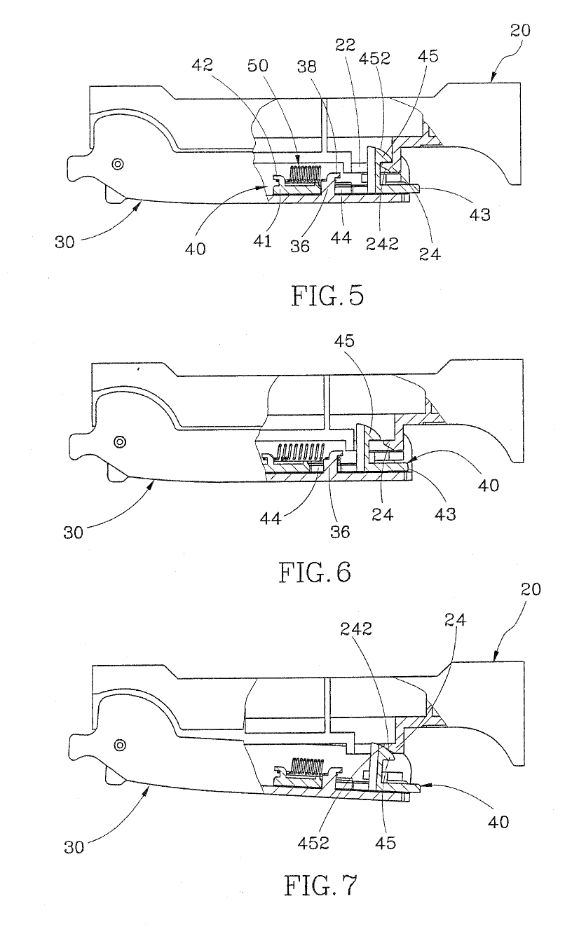

The base 20 is mounted on one side of the hard disk case (not shown) and provided a hole 22 through inner and outer sides thereof and a first retaining portion 24 protruding from a periphery wall surrounding the hole 22 and having a first inclined surface 242, as shown in FIG. 5.

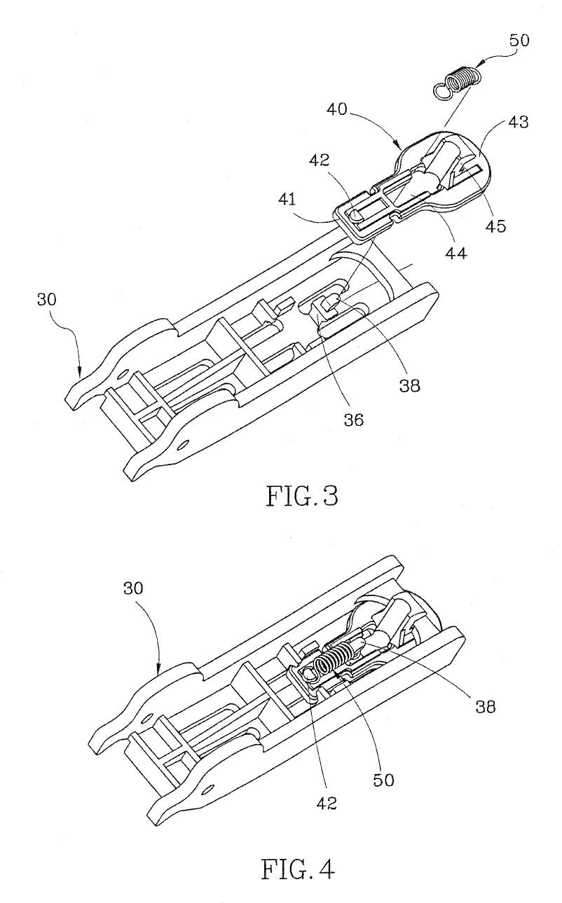

As shown in FIGS. 2 to 5, the handle 30 has a pivoting end 32 pivotally connected with the base by a pin 322 and provided with two protrusions 324, a connecting end 34, a block 36 on an inner side thereof, and a first hook portion 38 protruding outwardly from the block 36.

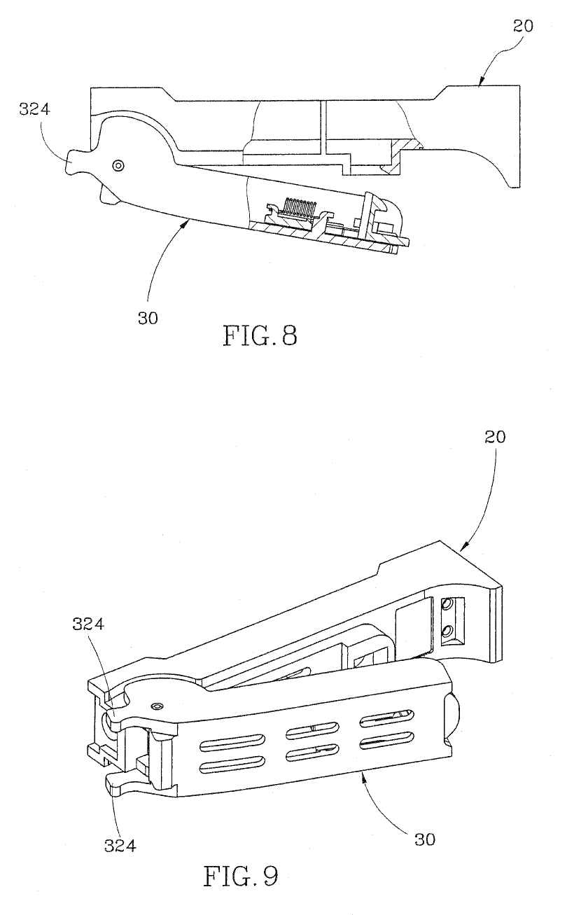

The movable member 40 has an insertion end 41, a second hook portion 42 protruding from the insertion end 41, a push end 43, a limiting groove 44 between the insertion end 41 and the push end 43, and a second retaining portion 45 in proximity of the limiting groove 44. The moveable member 40 is moveably installed in the handle 30 in such away that the insertion end 41 is inserted into the connecting end 34 of the handle 30, the push end 43 can be exposed out of the handle 30 for push by a user such that the movable member 40 can be movable relative to the handle 30 between a first position and a second position, the block 36 of the handle 30 is inserted through the limiting groove 44 for limiting the movement of the movable member 40, and the second retaining portion 45 can be inserted into the hole 22 of the base 20 and engaged with or disengaged from the first retaining portion 24 of the base 20 through the movement of the movable member 40. When the movable member 40 is located at the first position, as shown in FIG. 5, the block 36 of the handle 30 is stopped at the end of the limiting groove 44 that is adjacent to the insertion end 41, and the second retaining portion 45 of the movable member 40 is engaged with the first retaining portion 24 of the base 20 such that the handle 30 is firmly hooked on base 20 and cannot pivotally move relative to the base 20. When the movable member 40 is located at the second position, as shown in FIG. 6, the block 36 of the handle 30 is stopped at the end of the limiting groove 44 that is adjacent to the push end 43, and the second retaining portion 45 of the movable member 40 is disengaged from the first retaining portion 24 of the base 20 such that the handle 30 can be pulled outwardly to pivotally move relative to the base 20, as shown in FIGS. 8 and 9. Further, the second retaining portion 45 of the movable member 40 has a second inclined surface 452 with a inclined direction equal to that of the first inclined surface 242 of the base 20 such that the second inclined surface 452 of the movable member 40 can be abutted against and moved along the first inclined surface 242 of the base 20, as shown in FIG. 7, when the handle 30 is forced to move toward the base 20 for engagement with the base 20.

The elastic member 50 has two ends thereof respectively connected to the first hook portion 38 of the handle and the second hook portion 42 of the movable member 40 for providing a rebound force to the movable member 40 such that the movable member 40 can be driven to move from the second position to the first position when an external force that applies on the push portion 43 to hold the moveable member 40 at the second position is released from the push portion 43.

When wanting to disengage the connecting end 34 of the handle 30 from the base 20, a user may press the push end 43 of the movable member 40 to move the movable member 40 to the second position where the second retaining portion 45 of the movable member 40 is disengaged from the first retaining portion 24 of the handle 20, as shown in FIG. 6, such that the handle 30 is pivotable relative to the base 20 at this moment, as shown in FIGS. 8 and 9. And then, the user can pull the handle 30 outwardly to pivotally and continuously move the connecting end 34 away from the base 20 to an extent that the protrusions 324 of the handle 30 can stop against a computer case (now shown), such that the protrusions 324 can be served as a load point of a lever, i.e. the handle 30, to adversely drive the hard disk case (not shown) mounted with the base 20 to move outwardly, which in turn results in that a hard disk drive (not shown) installed in the hard disk case can be disconnected from a connector (not shown) of the computer case and removable out of the computer case.

On the other hand, when wanting to couple the connecting end 34 of the handle 30 to the base 20, the user may press the handle 30 to pivotally move toward the base 20 to an extent that the second inclined surface 452 of the second retaining portion 45 of the movable member 40 can be abutted against the first inclined surface 242 of the first retaining portion 24 of the base 20, as shown in FIG. 7. Next, the user may continuously press the handle 30 to make the second inclined surface 452 of the second retaining portion 45 of the movable member 40 move along the first inclined surface 242 of the first retaining portion 24 of the base 20 until the second retaining portion 45 of the movable member 40 is inserted into the hole 22 of the base 20. At this time, the movable member 40 will be pulled to move to the first position by the rebound force provided by the elastic member 50, as shown in FIG. 5, forcing the second retaining portion 45 of the movable member 40 to be engaged with the first retaining member 24 of the base 20, resulting in that the handle 30 cannot be pivoted relative to the base 20. At the time of pressing the handle 30, the hard disk drive (not shown) installed in the hard disk case (not shown) is forced to be electrically connected to the connector of the computer case (not shown), thereby fastening the hard disk case to the computer case.

In conclusion, the handle assembly of the present invention employs the reciprocal movement of the movable member to control the engagement and disengagement of the handle and the base. The way of using the two ends of the elastic member to respectively hook on the first hook portion and the second hook portion is convenient in assembly. Further, if the first retaining portion is damaged, the user can individually exchange the movable member without exchanging the whole handle, thereby enhancing convenience of repair and lowering maintenance cost.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A handle assembly for use in cooperation with a hard disk cases the handle assembly comprising:
a base having a first retaining portion;
a handle having a pivoting end pivotally connected with the base and a connecting end;
a movable member having a second retaining portion, said moveable member being mounted to the connecting end of the handle and movable between a first position where the second retaining portion of the movable member is engaged with the first retaining portion of the base such that the handle cannot be pivotable relative to the base, and a second position where the second retaining portion of the movable member is disengaged from the first retaining portion of the base such that the handle can be pivotable relative to the base; and
an elastic member having two ends respectively connected to the handle and the movable member for providing a rebound force to the movable member.

2. The handle assembly as claimed in claim 1, wherein the base has a hole for insertion of the second retaining portion of the movable member; the first retaining portion protrudes from a periphery wall surrounding said hole.

3. The handle assembly as claimed in claim 1, wherein the first retaining portion of the base has a first inclined surface and the second retaining portion of the movable member has a second inclined surface movable along the first inclined surface of the first retaining portion of the base.

4. The handle assembly as claimed in claim 1, wherein the two ends of the elastic member are respectively engaged with a first hook portion of the handle and a second hook portion of the movable member.

5. The handle assembly as claimed in claim 4, wherein the handle has a block, on which the first hook portion is formed, and the movable member has a limiting groove for insertion of the block of the handle.
